(19) United States
(12) Patent Application Publication
(10) Pub. No.: US 2015/0135304 A1
(43) Pub. Date: May 14, 2015

(54) ELECTRONIC APPARATUS AND CONTROL METHOD THEREOF

(71) Applicant: KABUSHIKI KAISHA TOSHIBA, Tokyo (JP)

(72) Inventor: Tetsuo Hatakeyama, Tokyo (JP)

(21) Appl. No.: 14/507,141

(22) Filed: Oct. 6, 2014

(30) Foreign Application Priority Data
Nov. 8, 2013 (JP) 2013-232264

(51) Int. Cl. H04L 29/06

(52) U.S. Cl. CPC H04L 63/0272; H04L 63/10
USPC 726/15

(57) ABSTRACT

According to one embodiment, an electronic apparatus is capable of switching a plurality of applications corresponding to a plurality of users in accordance with a selected user. The apparatus includes a communication controller which communicates with an apparatus connected to a network, a first determination controller which determines whether the selected user is a first user, a second determination controller which determines whether a connection is made to a first virtual private network server via the communication controller, and a first controller which controls use of the network by a first application corresponding to the first user and controls use of the network by a second application corresponding to a user in accordance with a determination results of the first and second determination controllers.

### CROSS-REFERENCE TO RELATED APPLICATIONS

This application is based upon and claims the benefit of priority from Japanese Patent Application No. 2013-232264, filed Nov. 8, 2013, the entire contents of which are incorporated herein by reference.

### FIELD

Embodiments described herein relate generally to an electronic apparatus connected to a virtual private network (VPN) and control method thereof.

### BACKGROUND

In recent years, companies draw attention to bringing an individually-owned information terminal or the like and using it in business (so-called Bring You Own Device (BYOD)). For information terminal, it is possible to use various electronic apparatuses such as tablet terminal and smartphone.

To realize BYOD, it is necessary to implement various security measures for an electronic apparatus.

Also, there is provided an electronic apparatus capable of switching a plurality of applications corresponding to a plurality of users in accordance with a selected user.

Further, an electronic apparatus outside company is connected to a company network via a virtual private network (VPN).

It is desired that when an electronic apparatus is connected to a VPN, the operation of an application corresponding to a selected user and the operation of an application corresponding to a non-selected user be controlled in accordance with a connected VPN and a selected user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus of an embodiment.

FIG. 2 is an exemplary figure illustrating a system structure comprising the electronic apparatus of the embodiment.

FIG. 3 is an exemplary block diagram illustrating the system structure of the electronic apparatus of the embodiment.

FIG. 4 is an exemplary figure illustrating a lock screen displayed in the LCD of the electronic apparatus of the embodiment.

FIG. 5 is an exemplary diagram illustrating each user's environment executed by the electronic apparatus of the embodiment.

FIG. 6 is an exemplary flowchart illustrating an example of the procedure of controlling using a network by an application executed by a connection control processing module of the electronic apparatus of the embodiment.

FIG. 7 is an exemplary flowchart illustrating an example of the procedure of controlling using a network by an application executed by the connection control processing module of the electronic apparatus of the embodiment.

FIG. 8 is an exemplary flowchart illustrating the procedure of processing by an application operation control processing module.

FIG. 9 is an exemplary figure illustrating controlling network use and application operation by an application.

FIG. 10 is an exemplary figure illustrating controlling network use and application operation by an application.

FIG. 11 is an exemplary figure illustrating controlling network use and application operation by an application.

FIG. 12 is an exemplary figure illustrating controlling network use and application operation by an application.

FIG. 13 is an exemplary figure illustrating controlling network use and application operation by an application.

FIG. 14 is an exemplary figure illustrating controlling network use and application operation by an application.

FIG. 15 is an exemplary figure illustrating controlling network use and application operation by an application.

FIG. 16 is an exemplary figure illustrating controlling network use and application operation by an application.

FIG. 17 is an exemplary figure illustrating controlling network use and application operation by an application.

FIG. 18 is an exemplary figure illustrating controlling network use and application operation by an application.

FIG. 19 is an exemplary figure illustrating controlling network use and application operation by an application.

FIG. 20 is an exemplary figure illustrating controlling network use and application operation by an application.

### DETAILED DESCRIPTION

Various embodiments will be described hereinafter with reference to the accompanying drawings.

In general, according to one embodiment, an electronic apparatus is capable of switching a plurality of applications corresponding to a plurality of users in accordance with a selected user. The apparatus includes a communication controller, a first determination controller, a second determination controller, and a first controller. The communication controller is configured to communicate with an apparatus connected to a network. The first determination controller is configured to determine whether the selected user is a first user. The second determination controller is configured to determine whether a connection is made to a first virtual private network server via the communication controller. The first controller is configured to control use of the network by a first application corresponding to the first user and to control use of the network by a second application corresponding to a user other than the first user in the plurality of users in accordance with a determination result of the first determination controller and a determination result of the second determination controller.

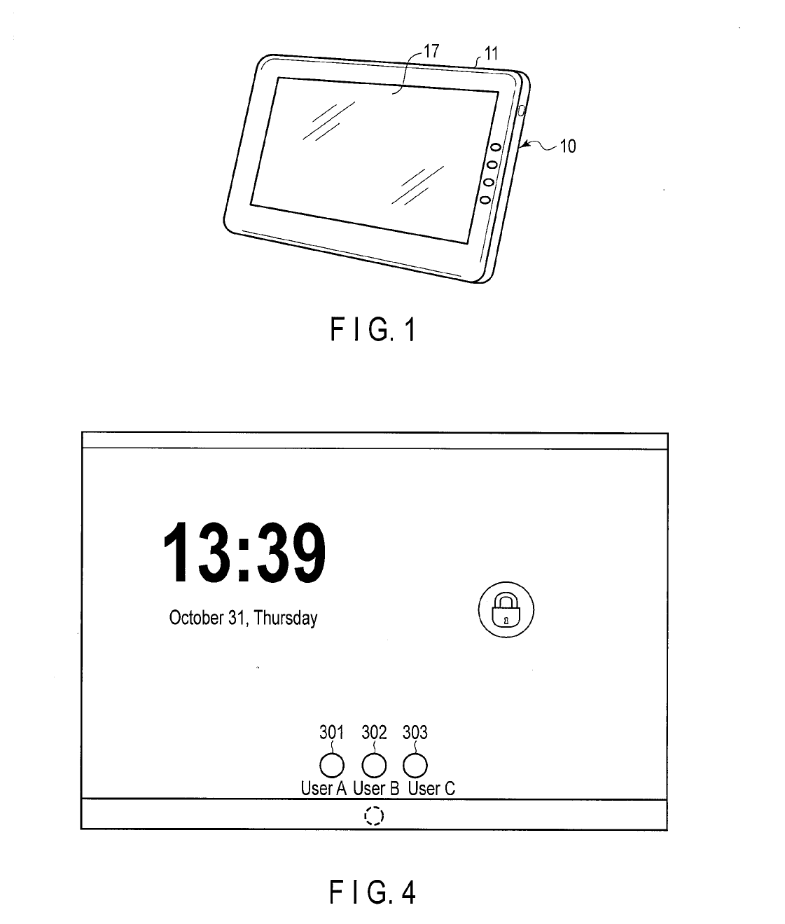

To begin with, the structure of an electronic apparatus of an embodiment will be explained with reference to FIG. 1. The electronic apparatus can be realized as a portable terminal such tablet personal computer, laptop or notebook personal computer and PDA. In the following, it is assumed that this electronic apparatus is realized as a tablet personal computer 10 (referred to as “computer 10” hereinafter).

FIG. 1 shows the external appearance of the computer 10. The computer 10 comprises a computer main body 11 and a touch screen display 17. The computer main body 11 has a thin box-type housing. The touch screen display 17 is arranged on the surface of the computer main body 11. The touch screen display 17 comprises a touchpanel and a flat panel display (for example, liquid crystal display device (LCD)). The touchpanel is arranged so as to cover the screen of the LCD. The touchpanel is configured to detect the position on the touch screen display 17 touched by a user's finger or a pen.

The computer 10 has a wireless communication device. The computer 10 can be connected to a Wireless Local Area network (WLAN) by the wireless communication device.

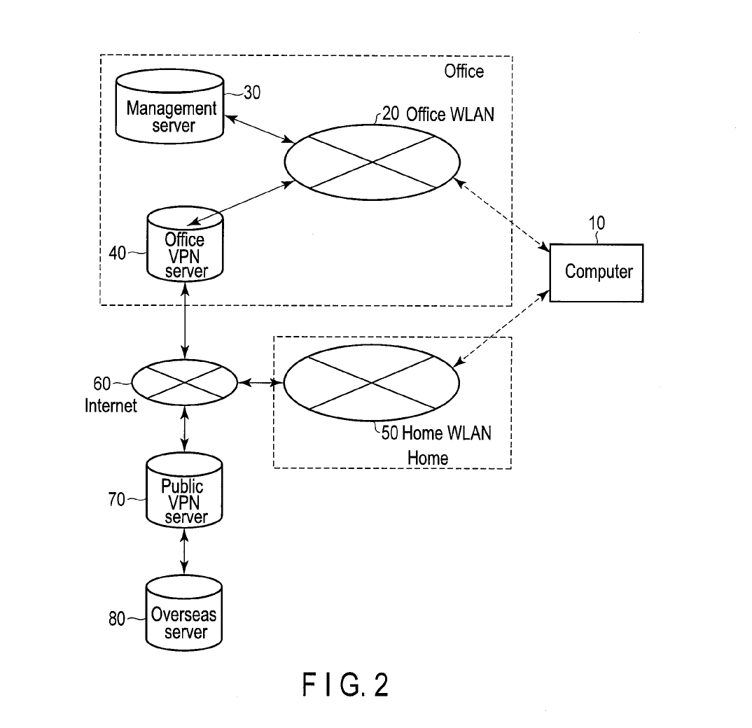

FIG. 2 is a figure illustrating an example of how the computer 10 is used.

For example, the computer 10 is connected to an office WLAN 20 when used in an office. The computer 10 can communicate with a management server 30 in an office when connected to the office WLAN 20.

The computer 10 is connected to a home WLAN 50 when used at home. When connected to the home WLAN 50, the computer 10 can communicate with a server connected to an Internet 60. The computer 10 can communicate with an office virtual private network (VPN) server 40 in an office. The computer 10 can be connected to the office WLAN 20 via the office VPN server 40 in an office. Also, the computer 10 can communicate with a public VPN server 70, which is located, for example, overseas. Even if there is an overseas server 80 that cannot be accessed from the computer 10 in a foreign country, the computer 10 can access to the overseas server 80 via the public VPN server 70.

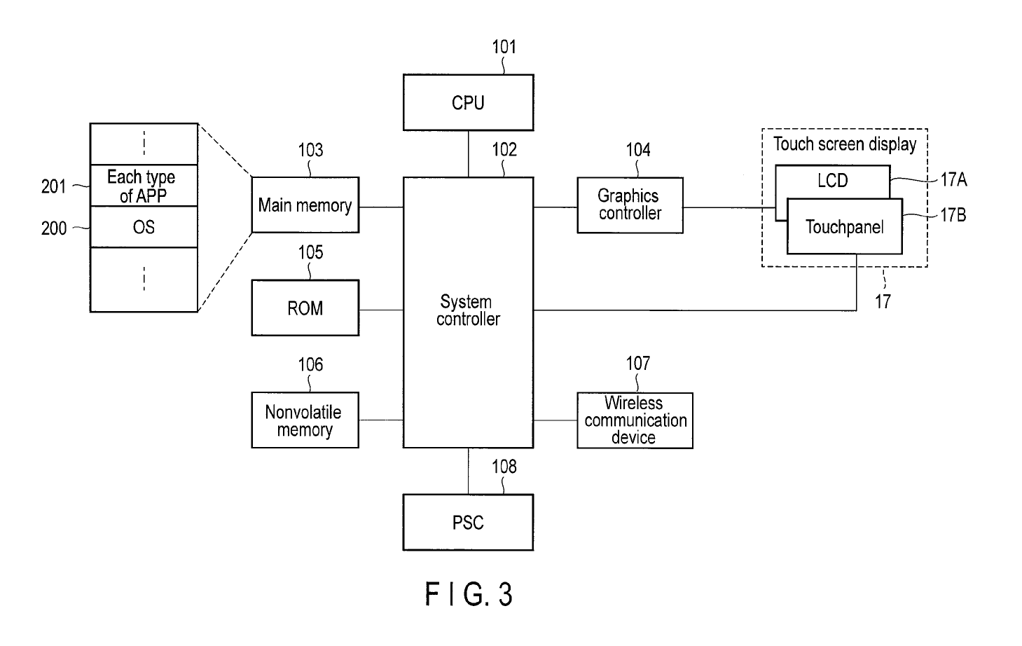

FIG. 3 is a block diagram illustrating the system of the electronic apparatus of the embodiment.

As shown in FIG. 3, the computer 10 comprises the touch screen display 17, a CPU 101, a system controller 102, a main memory 103, a graphics controller 104, an ROM 105, a nonvolatile memory 106, a wireless communication device 107 and a power supply controller (PSC) 108.

The CPU 101 is a processor to control the operation of each type of module in the computer 10. The CPU 101 executes each type of software loaded from the nonvolatile memory 106 (storage device) into the main memory 103 (nonvolatile memory). The software includes an operating system (OS) 200 and each type of application program 201.

The system controller 102 is a device that connects a local bus of the CPU 101 and each type of component. A memory controller configured to perform access control for the main memory 103 is built in the system controller 102. Also, the system controller 102 has a function to execute communication with the graphics controller 104 via a serial bus in PCI EXPRESS standard.

The graphics controller 104 is a display controller configured to control an LCD 17A used as a display monitor of the computer 10. A display signal generated by the graphics controller 104 is transmitted to the LCD 17A. The LCD 17A displays a screen image based on a display signal. A touchpanel 17B is arranged on the LCD 17A. The touchpanel 17B is an electrostatic capacity type pointing device to input on the screen of the LCD 17A. The contact location on the screen contacted by a finger, the shift of the contact location and the like are detected by the touchpanel 17B.

The wireless communication device 107 is a device configured to execute wireless communication such WLAN and 3G mobile communication.

The power supply controller 108 is a single-chip micro computer for power supply management. The power supply controller 108 has a function to turn on, turn off or sleep the computer 10 in accordance with a user's pressing the power supply button.

Also, the power supply controller 108 uses electricity supplied from the battery in the computer 10 to generate operation electricity that should be supplied to each component. Further, the power supply controller 108 charges a battery by using electricity supplied from an external power supply.

The ROM 105 stores a boot loader. When turned on, the CPU 101 boots the boot loader to boot the operating system 200.

It is possible to set a plurality of users for the computer 10. As a plurality of applications corresponding to a plurality of users can be switched in accordance with a selected user, the LCD 17A displays a screen generated by a switched application.

A lock screen shown in FIG. 4 is displayed when the computer 10 is booted or returned from sleep. As shown in FIG. 4, three buttons 301, 302 and 303 corresponding to users A, B and C, respectively, are displayed. Note that by tapping any of the three buttons 301, 302 and 303, a screen generated by an application included in the environment of a user corresponding to a button is displayed.

Note that user A is a user set initially for a computer and will be described as “owner user” hereinafter. It is not possible to delete the setting of an owner user. Even if a user other than an owner user is selected, the application of an owner user is executed and cannot be stopped. User B is set to be used in an office and will be called “office user” hereinafter. User C is set to be used in a place other than an office and will be called “additional user” hereinafter.

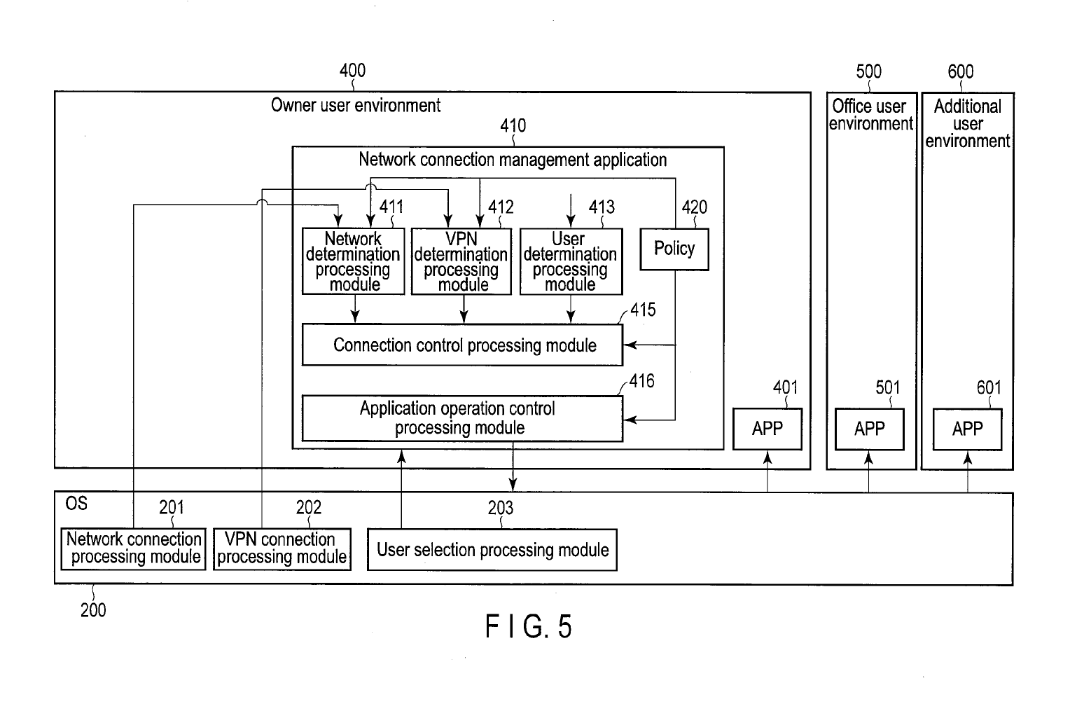

FIG. 5 is a diagram illustrating each user's environment executed by the computer 10.

As shown in FIG. 5, it is possible to execute an owner user environment 400 corresponding to an owner user, an office user environment 500 corresponding to an office user and an additional user environment 600 corresponding to an additional user on the operating system 200.

In the operating system 200, a network connection processing module 201, a VPN connection processing module 202 and a user selection processing module 203 are executed.

The network connection processing module 201 executes identification processing between the network connection processing module 201 and an access point, when it is possible to connect with a WLAN by the instruction of connection by a user's operation or in each WLAN environment. The network connection processing module 201 executes the processing of network communication when identification is successfully done. Also, the network connection processing module 201 notifies a network connection management application 410 of occurrence of network connection start when starting to connect with a WLAN. The network connection processing module 201 includes in the notification the SSID of the access point connected in a WLAN as information of WLAN that starts connecting. Further, the network connection processing module 201 notifies the network connection management application 410 of occurrence of network connection end when the connection with a WLAN is stopped. The network connection processing module 201 includes in the notification the SSID of the access point connected in a WLAN as information of WLAN that ends connection.

The VPN connection processing module 202 executes identification processing with a VPN server. The VPN connection processing module 202 executes the processing of VPN communication when identification is successfully done. The VPN connection processing module 202 notifies the network connection management application 410 of occurrence of network connection start when starting to connect with a WLAN. The VPN connection processing module 202 includes in the notification information of a VPN server (IP address and domain name) as VPN information that starts connecting. The VPN connection processing module 202 notifies the network connection management application 410 of occurrence of network connection end when the connection with a WLAN is stopped. The VPN connection processing module 202 includes in the notification information of a VPN server as VPN information that ends connection.

The user selection processing module 203 displays the screen shown in FIG. 4 on the touch screen display 17. The user selection processing module 203 boots an environment corresponding to a selected user. The user selection processing module 203 notifies the network connection management application 410 of occurrence of a user selection including information of a selected user. The user selection processing module 203 notifies the network connection management application 410 of information of a selected user in accordance with the user's operation of selecting a user.

In the owner user environment 400, an owner application (APP) 401, a network connection management application (APP) 410 and the like are executed. In the office user environment 500, an office application 501 (APP) and the like are executed. In the additional environment 600, an additional user application 601 (APP) and the like are executed.

The owner user environment 400, the office user environment 500 and the additional environment 600 have an authority to access to the network connection processing module 201. The owner user environment 400 has an authority to access to the VPN connection processing module 202. The office user environment 500 and the additional environment 600 do not have an authority to access to the VPN connection processing module 202.

The network connection management application 410 comprises a network determination processing module 411, a VPN determination processing module 412, a user determination processing module 413, a connection control processing module 415 and an application operation control processing module 416 (APP operation control processing module). The network connection management application 410 is assigned a system privilege so as not to be stopped during booting of the computer 10.

The network connection management application 410 comprises a policy 420 including information of a WLAN that permits an office user to make connection when there is no VPN connection, information of a VPN server that permits an office user to make connection, information of a WLAN that prohibits an owner user and an additional user from making connection and information of a VPN server that prohibits an owner user and an additional user from making connection.

The policy 420 includes the SSID of the access point in the office WLAN 20 as information of a WLAN that permits an office user to make connection when there is no VPN connection. The policy 420 retains information of the IP address or domain name of the office VPN server 40 as information of a VPN server that permits an office user to make VPN connection.

The policy 420 has information of an application that cannot be executed simultaneously with other user applications in user applications other than the owner application 401. In the present embodiment, the policy 420 includes information indicative of the office application 501 as information of an application that cannot be executed simultaneously with other user applications.

When not connected to a VPN server but to a WLAN, the network determination processing module 411 determines whether the connected WLAN is a WLAN that permits an office user to make connection, i.e., the office WLAN 20, based on the policy 420 and the SSID of the access point of a WLAN. The network determination processing module 411 notifies the connection control processing module 415 of a determination result.

When connected to a network, the VPN determination processing module 412 determines whether the VPN determination processing module 412 is connected to a VPN server. When it is determined that the VPN determination processing module 412 is connected to the VPN server, the VPN determination processing module 412 determines whether the connected VPN server is a server that permits an office user to connect with the office WLAN 20 via the office VPN server 40, i.e., the office VPN server 40, based on the policy 20 and the IP address and domain name of and the connected VPN server. The VPN determination processing module 412 notifies the connection control processing module 415 of a determination result.

The user determination processing module 413 determines whether a user being selected or a user being executed is a user permitted to connect to the office WLAN 20 directly or via the office VPN server 40, i.e., an office user, based on the policy 420 and a user notified from the user selection processing module 203. The user determination processing module 413 notifies the connection control processing module 415 of a determination result.

Upon receipt of notification of occurrence of user selection, network connection start, network connection end, VPN connection start or VPN connection end, the connection control processing module 415 controls using a network by the office application 501 and controls using a network by the owner application 401 and the additional user application 601, based on the determination results of the network determination processing module 411, the VPN determination processing module 412 and the user determination processing module 413.

The connection control processing module 415 notifies a request of ending network connection use restriction and lifts the restriction of network connection use of the office application 501 corresponding to an office user, when an office user is selected or used and there is no active network connection or VPN connection.

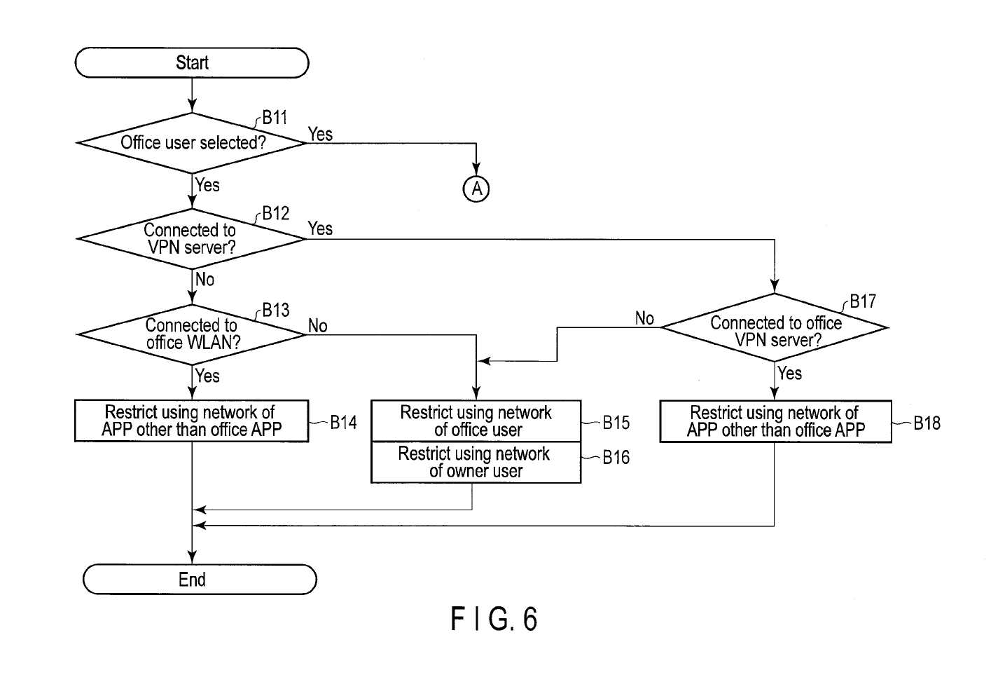

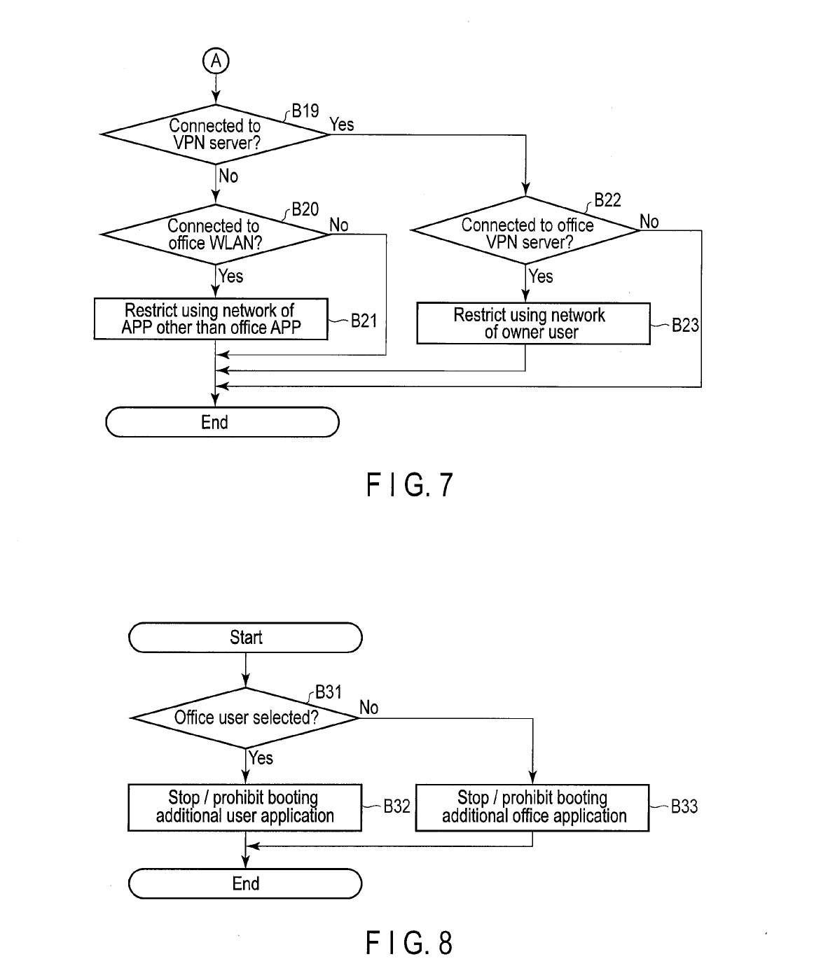

FIGS. 6 and 7 are flowcharts illustrating the procedure of controlling using a network by an application executed by the connection control processing module 415.

The connection control processing module 415 determines whether an office user is being selected or executed based on the determination result of the connection control processing module 415, when a user is selected, when connection is made to a WLAN or when connection is made to a VPN server (block B11). When it is determined that an office user is being selected or executed (block B11, Yes), the connection control processing module 415 determines whether connection is made to a VPN server based on the determination result of the VPN determination processing module 412 (block B12). When it is determined that connection is not made to a VPN server (block B12, NO), the connection control processing module 415 determines whether connection is made to the office WLAN 20 that permits an office user to connect when there is no VPN connection, based on the determination result of the network determination processing module 411 (block B13). When it is determined that connection is made to a VPN server (block B13, YES), the connection control processing module 415 requests the network connection processing module 201 to restrict (prohibit) using an application network corresponding to a user other than the user of the office application 501 (block B14). When it is determined that connection is not made to the office WLAN 20 (block B13, NO), the connection control processing module 415 requests the network connection processing module 201 to restrict using the network of the office application 501 (block B15). The connection control processing module 415 requests the network connection processing module 201 to restrict using the network of the owner application 401 (block B16). Note that block B15 and block B16 may be executed in the opposite order.

In block B12, when it is determined that connection is made to a VPN server (block B12, YES), the connection control processing module 415 determines whether connection is made to the office VPN server 40 that permits an office user to make VPN connection, based on the determination result of the VPN determination processing module 412 (block B17). When connection is made to the office VPN server 40 (block B17, YES), the connection control processing module 415 requests the network connection processing module 201 to restrict using an application network corresponding to a user other than the user of the office application 501 (block B18).

When it is determined that connection is not made to the office VPN server 40 (block B17, NO), the connection control processing module 415 requests the network connection processing module 201 to restrict using the network of the office application 501 (block B15). The connection control processing module 415 requests the network connection processing module 201 to restrict using the network of the owner application 401 (block B16). Note that block B15 and block B16 may be executed in the opposite order.

When it is determined that an office user is not selected (block B11, NO), the connection control processing module 415 determines whether connection is made to a VPN server based on the determination result of the VPN determination processing module 412 (block B19). When it is determined that connection is not made to a VPN server (block B19, NO), the connection control processing module 415 determines whether connection is made to the office WLAN 20 that prohibits a user other than an office user from making connection when there is no VPN connection, based on the SSID of the access point of a connected WLAN and based on the determination result of the network determination processing module 411 (block B20). When it is determined that connection is made to the office WLAN 20 (block B20, YES), the connection control processing module 415 requests the network connection processing module 201 to restrict using a network of an application corresponding to a user other than the user of the office application 501 (block B21). When it is determined that connection is not made to the office WLAN 20 (block B20, NO), the connection control processing module 415 ends the processing.

In block B19, when it is determined that connection is made to a VPN server (block B19, YES), the connection control processing module 415 determines whether connection is made to the office VPN server 40 that prohibits a user other than an office user from making VPN connection, based on the determination result of the VPN determination processing module 412 (block B22). When connection is made to the office VPN server 40 (block B22, YES), the connection control processing module 415 requests the network connection processing module 201 to restrict using an application network by the owner application 401 (block B23). When it is determined that connection is not made to the office WLAN 20 (block B22, NO), the connection control processing module 415 ends the processing.

The application operation control processing module 416 executes operation control processing of an application in a user application other than the owner application 401 included in the policy 420, based on the information of an application that cannot be executed simultaneously with other user applications.

The application operation control processing module 416 stops an application corresponding to a user other than an office user or an owner and prohibits booting an application corresponding to a user other than an office user or an owner, when an office user is selected at the time of selecting a user.

The application operation control processing module 416 stops and prohibits booting the office application 501 corresponding to an office user and prohibits booting the office application 501 corresponding to an office user, when an owner user or an additional user is selected at the time of selecting a user.

FIG. 8 is a flowchart illustrating the processing procedure of processing by the application operation control processing module 416.

The application operation control processing module 416 determines whether an office user is selected, at the time of selecting a user (block B31). When it is determined that an office user is selected (block B31, YES), the application operation control processing module 416 requests the operating system 200 to stop and to prohibit booting an application other than the owner application 401 and the office application 501, i.e., the additional user application 601 (block B32). Upon the request, the operating system 200 stops the additional user application 601 and prohibits booting the additional user application 601. When it is determined that an office user is not selected (block B31, NO), the application operation control processing module 416 requests the operating system 200 to stop and to prohibit booting the office application 501 (block B33). Upon the request, the operating system 200 stops and prohibits booting the office application 501.

As a result of connection processing in the network connection processing module 201 and the VPN connection processing module 202, when the computer 10 is connected to the office WLAN 20 or VPN-connected to the office VPN server 40 and can communicate with the management server 30, the network connection management application 410 confirms with the management server 30 the presence or absence of a new policy to update the policy 420, receives the new policy if it exists, and updates the policy 420.

Following are examples of controlling the use of an application network and controlling the operation of an application.

When an office user is selected or used and connection is not made to a VPN server but to a VPN server, the network connection management application 410 notifies a request of ending network connection use restriction and lifts the restriction of using network connection of a user application that is being selected or used.

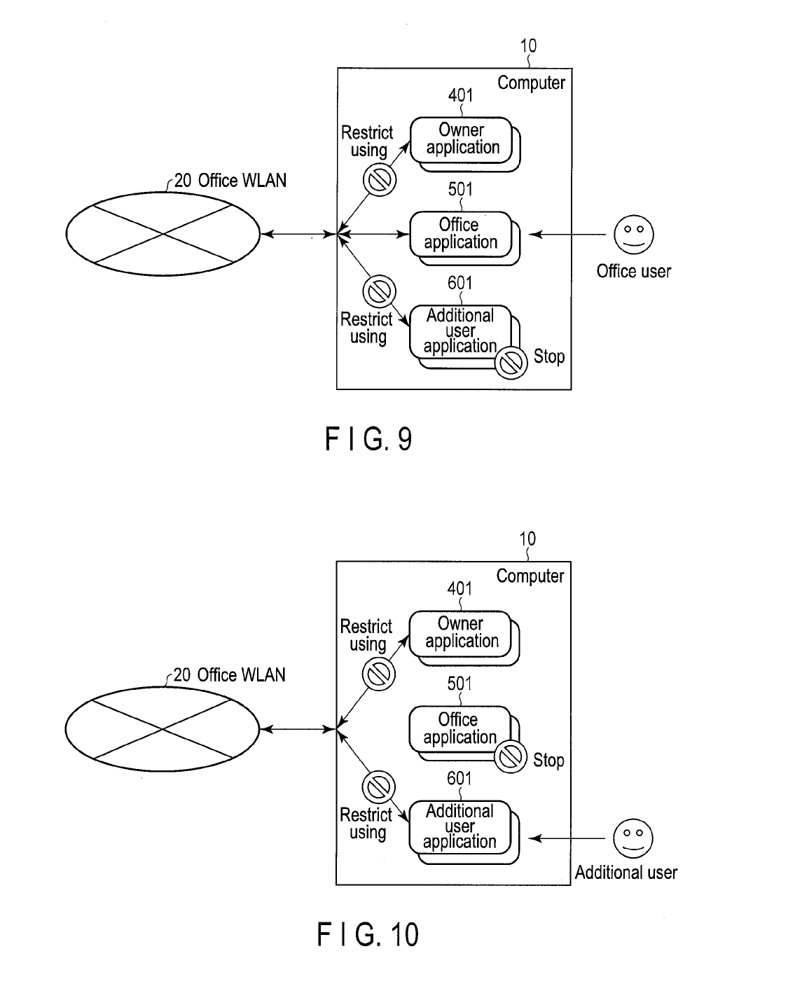

As shown in FIG. 9, when an office user is selected or used and connection is made not to a VPN server but to the office WLAN 20, the connection control processing module 415 notifies the network connection processing module 201 of a request of ending network connection use restriction to the office application 501. Upon the notification, the network connection processing module 201 lifts the restriction of using network connection of the office application 501. Also, the connection control processing module 415 notifies the network connection processing module 201 of a request of starting to restrict using networking connection to the owner application 401. Upon the notification, the network connection processing module 201 starts restriction of using network connection of the owner application 401. Also, the application operation control processing module 416 requests the operating system 200 to stop and to prohibit booting the additional user application 601.

As shown in FIG. 10, when an additional user is selected or used and connection is made not to a VPN server but to the office WLAN 20, the connection control processing module 415 notifies the network connection processing module 201 of a request of starting network connection use restriction to the owner application 401 and the additional user application 601. Upon the notification, the network connection processing module 201 starts the restriction of using network connection of the owner application 401 and the additional user application 601. Also, the application operation control processing module 416 requests the operating system 200 to stop and to prohibit booting the office application 501.

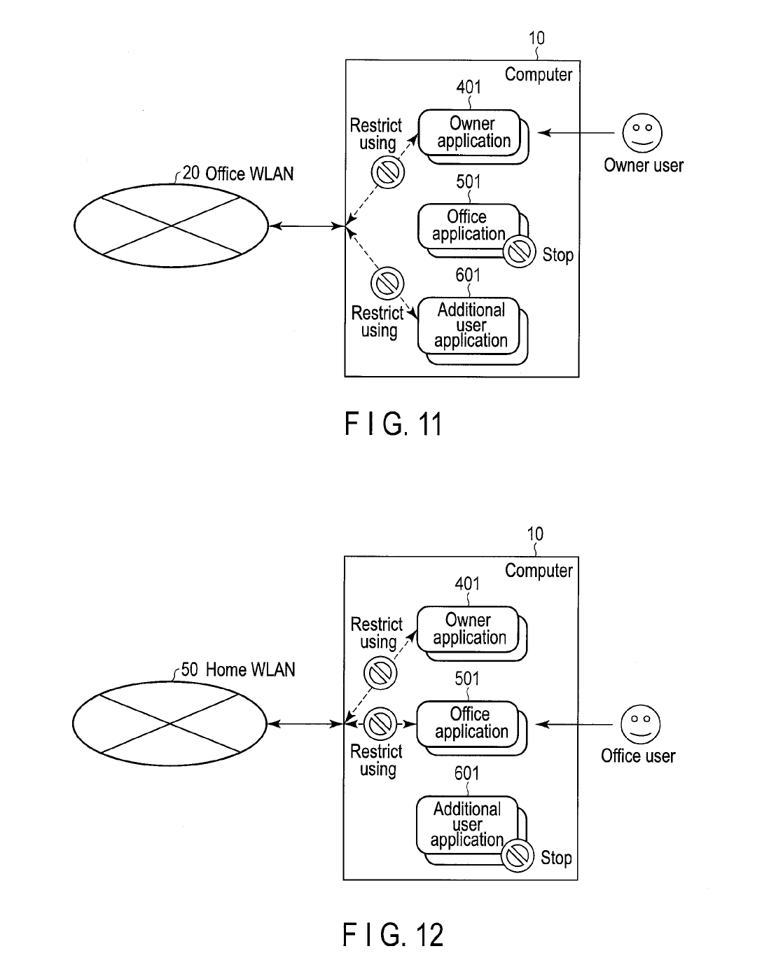

As shown in FIG. 11, when an owner user is selected or used and connection is made not to a VPN server but to the office WLAN 20, the connection control processing module 415 notifies the network connection processing module 201 of a request of starting network connection use restriction to the owner application 401 and the additional user application 601. Upon the notification, the network connection processing module 201 starts the restriction of using network connection of the owner application 401 and the additional user application 601. Also, the application operation control processing module 416 requests the operating system 200 to stop and to prohibit booting the office application 501.

As shown in FIG. 12, when an office user is selected or used and connection is made not to a VPN server but to the home WLAN 50 other than the office WLAN 20, the connection control processing module 415 notifies the network connection processing module 201 of a request of starting network connection use restriction to the owner application 401 and the office application 501. Upon the notification, the network connection processing unit 201 starts the restriction of using network connection of the owner application 401 and the office application 501. Also, the application operation control processing module 416 requests the operating system 200 to stop and to prohibit booting the additional user application 601.

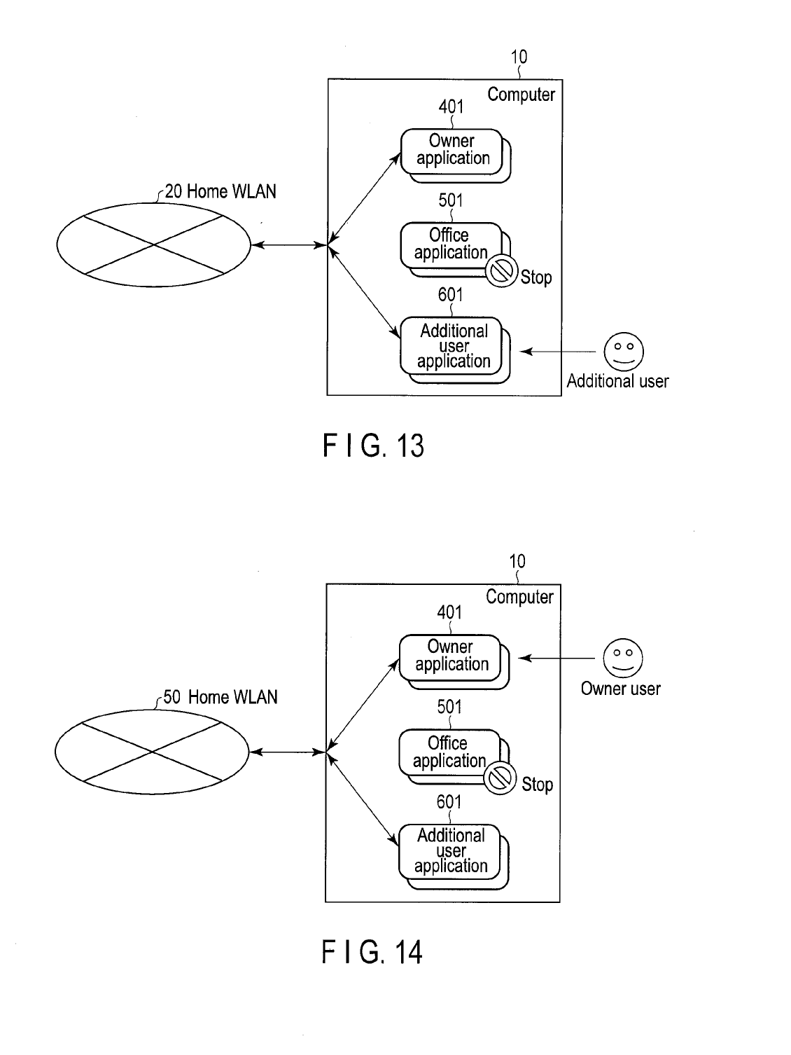

As shown in FIG. 13, when an additional user is selected or used and connection is made not to a VPN server but to the home WLAN 50 other than the office WLAN 20, the connection control processing module 415 notifies the network connection processing module 201 of a request of ending network connection use restriction to the owner application 401 and the additional user application 601. Upon the notification, the network connection processing module 201 lifts the restriction of using network connection of the owner application 401 and the additional user application 601. Also, the application operation control processing module 416 requests the operating system 200 to stop and to prohibit booting the office application 501.

As shown in FIG. 14, when an owner user is selected or used and connection is made not to a VPN server but to the home WLAN 50 other than the office WLAN 20, the connection control processing module 415 notifies the network connection processing module 201 of a request of ending network connection use restriction to the owner application 401 and the additional user application 601. Upon the notification, the network connection processing module 201 lifts the restriction of using network connection of the owner application 401 and the additional user application 601. Also, the application operation control processing module 416 requests the operating system 200 to stop and to prohibit booting the office application 501.

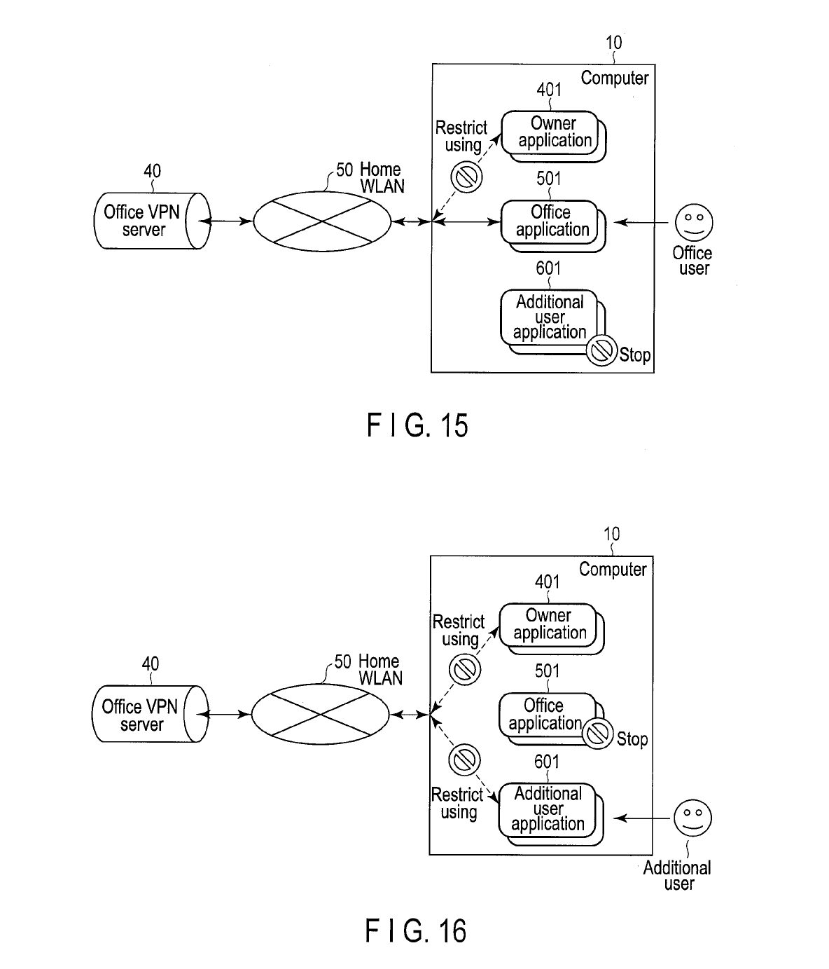

As shown in FIG. 15, when an office user is selected or used and connection is made to the office VPN server 40, the connection control processing module 415 notifies the network connection processing module 201 of a request of ending network connection use restriction to the office application 501. Upon the notification, the network connection processing module 201 lifts the restriction of using network connection of the office application 501. Also, the connection control processing module 415 notifies the network connection processing module 201 of a request of starting network connection use restriction to the owner application 401. Upon the notification, the network connection processing module 201 starts the restriction of using network connection of the owner application 401. Also, the application operation control processing module 416 requests the operating system 200 to stop and to prohibit booting the additional user application 601.

As shown in FIG. 16, when an additional user is selected or used and connection is made to the office VPN server 40, the connection control processing module 415 notifies the network connection processing module 201 of a request of starting network connection use restriction to the owner application 401 and the additional user application 601. Upon the notification, the network connection processing module 201 starts the restriction of using network connection of the owner application 401 and the additional user application 601. Also, the application operation control processing module 416 requests the operating system 200 to stop and to prohibit booting the office application 501.

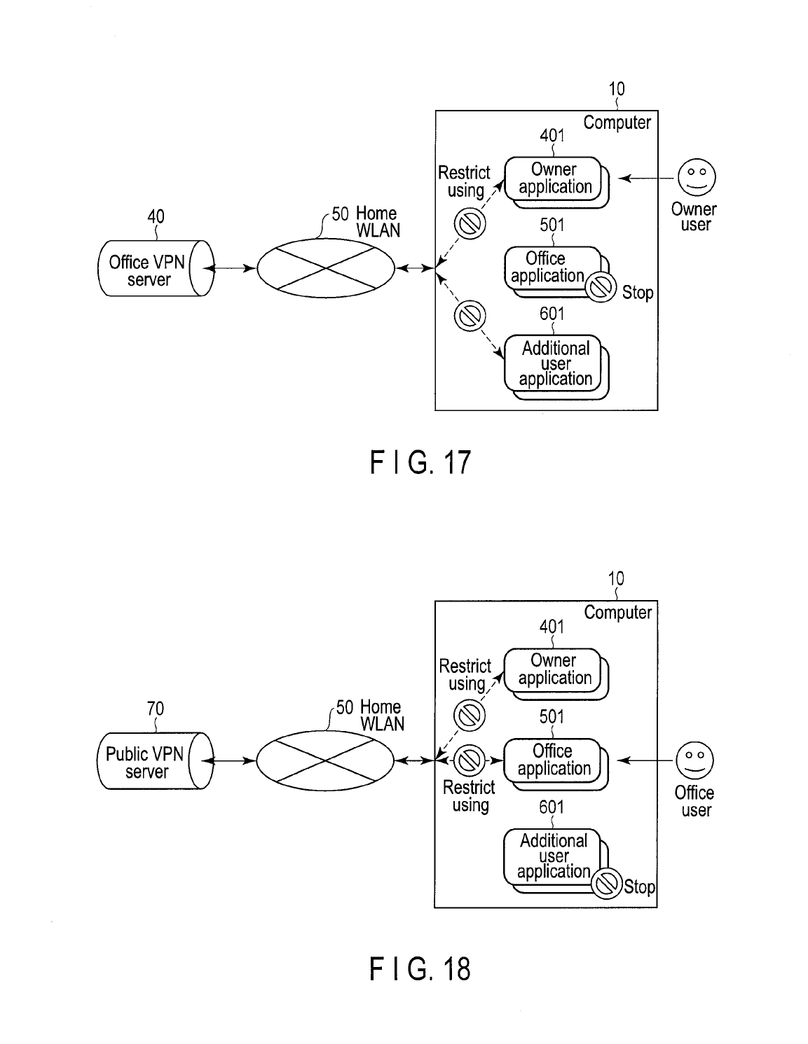

As shown in FIG. 17, when an owner user is selected or used and connection is made to the office VPN server 40, the connection control processing module 415 notifies the network connection processing module 201 of a request of starting network connection use restriction to the owner application 401 and the additional user application 601. Upon the notification, the network connection processing module 201 starts the restriction of using network connection of the owner application 401 and the additional user application 601. Also, the application operation control processing module 416 requests the operating system 200 to stop and to prohibit booting the office application 501.

As shown in FIG. 18, when an office user is selected or used and connection is made to the public VPN server 70 other than the office VPN server 40, the connection control processing module 415 notifies the network connection processing module 201 of a request of starting network connection use restriction to the owner application 401 and the office application 501. Upon the notification, the network connection processing module 201 starts the restriction of using network connection of the owner application 401 and the office application 501. Also, the application operation control processing module 416 requests the operating system 200 to stop and to prohibit booting the additional user application 601.

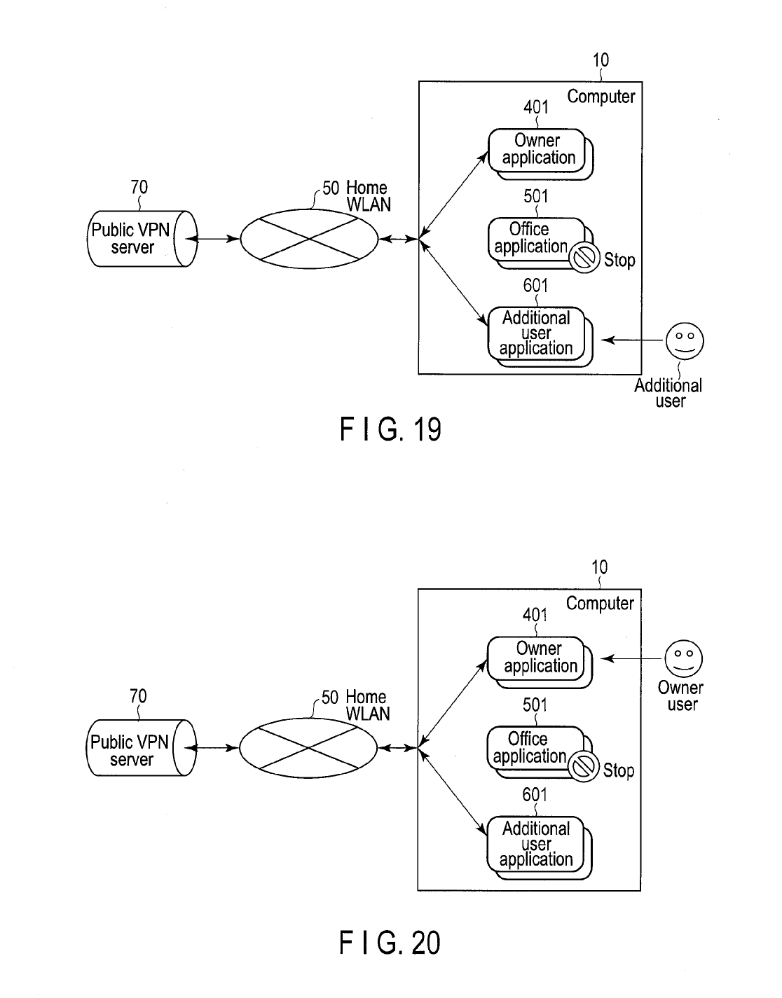

As shown in FIG. 19, when an additional user is selected or used and connection is made to the public VPN server 70 other than the office VPN server 40, the connection control processing module 415 notifies the network connection processing module 201 of a request of ending network connection use restriction to the owner application 401 and the additional user application 601. Upon the notification, the network connection processing module 201 lifts the restriction of using network connection of the owner application 401 and the additional user application 601. Also, the application operation control processing module 416 requests the operating system 200 to stop and to prohibit booting the office application 501.

As shown in FIG. 20, when an owner user is selected or used and connection is made to the public VPN server 70 other than the office VPN server 40, the connection control processing module 415 notifies the network connection processing module 201 of a request of ending network connection use restriction to the owner application 401 and the additional user application 601. Upon the notification, the network connection processing module 201 lifts the restriction of using network connection of the owner application 401 and the additional user application 601. Also, the application operation control processing module 416 requests the operating system 200 to stop and to prohibit booting the office application 501.

According to the above-mentioned operation, when a user selects an office user and the computer 10 and there is no connection to a VPN server, the computer 10 is permitted to connect only to the office WLAN 20. When a user selects an office user and uses the computer 10, the computer 10 is permitted to connect only to the office VPN server 40. As a result, the office application 501 can use only the office WLAN 20 directly or via the office VPN server 40.

Note that stopping the office application 501 means restricting using a network by the office application 501.

When an additional user or an owner user is selected and used, it is prohibited to connect the computer 10 to the office WLAN 20 and the office VPN server 40 and to use the office WLAN 20 for the application of an additional user and an owner user.

By determining whether an office user is selected and by determining whether connection is made to the office VPN server 40, it is possible to control the operation of an application in accordance with the determination result, i.e., a connected VPN and a selected user.

Also, since each type of processing in the present embodiment can be realized by a computer program, the same effect as the present embodiment can be easily realized only by installing and executing the computer program to a normal computer through a computer-readable storage medium that stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus capable of switching a plurality of applications corresponding to a plurality of users in accordance with a selected user, the apparatus comprising:
a communication controller configured to communicate with an apparatus connected to a network;
a first determination controller configured to determine whether the selected user is a first user;
a second determination controller configured to determine whether a connection is made to a first virtual private network server via the communication controller; and
a first controller configured to control use of the network by a first application corresponding to the first user and to control use of the network by a second application corresponding to a user other than the first user in the plurality of users in accordance with a determination result of the first determination controller and a determination result of the second determination controller.

2. The apparatus of claim 1, wherein the first controller is configured to permit the first application to use the network and to prohibit the second application from using the network when the first determination controller determines that the first user is selected and the second determination controller determines that the connection is made to the first virtual private network server.

3. The apparatus of claim 1, wherein the first controller is configured to prohibit the first application from using the network and to prohibit the second application from using the network when the first determination controller determines that a user other than the first user in the plurality of users is selected and the second determination controller determines that the connection is made to the first virtual private network server.

4. The apparatus of claim 1, wherein the first controller is configured to prohibit the first application from using the network and to prohibit the second application from using the network when the first determination controller determines that the first user is selected and the second determination controller determines that the connection is not made to the first virtual private network server.

5. The apparatus of claim 1, wherein the first controller is configured to prohibit the first application from using the network and to permit the second application to use the network when the first determination controller determines that a user other than the first user in the plurality of users is selected and the second determination controller determines that the connection is not made to the first virtual private network server.

6. The apparatus of claim 1, further comprising a second controller configured to stop a third application corresponding to a second user in the plurality of users when the first user is selected.

7. The apparatus of claim 6, wherein the second controller configured to stop the first application when the second user is selected.

8. The electronic apparatus of claim 6, wherein the second controller does not stop the second application when the first user or the third user is selected.

9. A method for controlling an electronic apparatus capable of switching a plurality of applications corresponding to a plurality of users in accordance with a selected user, the method comprising:
executing first determination processing of determining whether the selected user is a first user;
executing second determination processing of determining whether a connection is made to a first virtual private network server; and
controlling use of the network by a first application corresponding to the first user and controlling use of the network by a second application corresponding to a user other than the first user in the plurality of users in accordance with a determination result of the first determination processing and a determination result of the second determination processing.

10. A computer readable, non transitory storage medium configured to store a computer program which is executable by a computer, the computer program controlling the computer to execute functions of:
executing first determination processing of determining whether the selected user is a first user;
executing second determination processing of determining whether a connection is made to a first virtual private network server; and
controlling use of the network by a first application corresponding to the first user and controlling use of the network by a second application corresponding to a user other than the first user in the plurality of users in accordance with a determination result of the first determination processing and a determination result of the second determination processing.
